(19) United States
(12) Patent Application Publication
(10) Pub. No.: US 2011/0073595 A1
(43) Pub. Date: Mar. 31, 2011

(54) COLLAPSIBLE FREIGHT CONTAINER

(76) Inventor: Murray Crane, Calgary (CA)

(21) Appl. No.: 12/691,941

(22) Filed: Jan. 22, 2010

Related U.S. Application Data
(60) Provisional application No. 61/258,779, filed on Nov. 6, 2009.

(30) Foreign Application Priority Data
Sep. 30, 2009 (CA) 2681296
Oct. 13, 2009 (CA) 2682416

(51) Int. Cl. B65D 88/00; B23P 19/00; B65B 5/00

(52) U.S. Cl. 220/1.5; 29/426.1; 53/473

(57) ABSTRACT

A collapsible freight container that is lightweight, and which includes improvements to improve ease of loading and storage. Collapsible support yokes are attached along the side edges of the freight deck and are configured to be movable between storage, transport and loading positions. With the support yokes struck down into their storage positions, the collapsed container takes on a minimum space configuration and can be densely stored or transported. The freight container is further adapted to be stackable when loaded. The container is configured to be moveable with existing standard top lifting equipment in use in the intermodal freight handling industry. Methods of transport, loading and storage using this container are also disclosed.

### FIELD OF THE INVENTION

The invention is in the field of freight containers, in particular stackable freight containers for use in intermodal transport applications.

### BACKGROUND

Freight transfer requires the use of containers of specified outside dimensions and minimum weight, while having the largest internal freight carrying dimensions and load capacity. For overland transport, rail transfer provide a particular advantage, since it offers a more economical means of transporting goods as compared to other methods such as trucking. Containers come in various sizes including 20′, 40′, 45′, 48, and 53′ lengths that are stackable in various configurations. Over the years this method of containerized freight transport has developed and is referred to as “intermodal” transport insofar as the containers which have been developed have been developed in conjunction with rail cars, trailer chassis and other shipping and lifting equipment so that the standardized containers can be moved from one mode of transport to another easily and quickly.

Most intermodal containers are closed box configurations that take up the same volume regardless of whether they are full or empty. Top lifting equipment is commonly used in the industry, and typically requires the presence of top lifting fittings on the container being handled. In addition, the top lifting equipment requires that the fittings be positioned in pairs on each side of the container, and each side pair of fittings being spaced apart by approximately 40 feet.

Insofar as most intermodal containers to date have been box type containers, there are a couple of improvements which would assist in the general furtherance of the intermodal transport industry. Firstly, if the shipping container could be developed without walls, the removal of the steel walls and roof from the container could allow for a significant reduction in the weight of the container which would allow for an increase in the amount of load which could be carried by each container and would thus make containerization and transport using such a modified container more feasible or economically beneficial.

Certain experiments have been conducted in the past with freight decks manufactured to the standard dimensions of shipping containers such that they could be effectively treated as containerized freight but there have been problems with this to date as well. Firstly, as the length of the freight decks has extended beyond 40 feet, which is the typical lifting length of the container, the use of rigidly attached arches or the like as lifting points for the freight deck have limited the ease with which cargo which is the full length of the freight deck could be loaded. The freight deck could not be loaded from the top if a rigidly attached arch or support yoke was used, since it was difficult if not impossible to top load full-length cargo which extended beyond the distance between the lifting points on the container i.e. in the context of a 52 foot freight deck if the support arches or yokes were attached 40 feet apart, this would lead a 6 foot extension of the freight deck beyond either support arch which was difficult to reach in loading the container.

One of the other problems with these containers in the past which has limited their commercial adoption has been the relative inability to feasibly and economically store them when not in use. For the amount of material, they are not efficiently stored volumetrically since other than the support arches or support yokes extending about the freight deck, the freight deck itself is the primary bulk of such a freight deck or container and large stacking heights of low density would be accomplished or achieved in the stacking of these items for storage. If it were possible to design a standardized freight deck of containerized dimensions which would allow for complete end to end top loading of the freight deck, for the loading of long freight outside the lifting length of the container, and which would also provide for an optimized ability to stack the empty containers, it is believed that this would be desirable in the market context. Not only would a greater storage density enhance the attractiveness of this type of a container or transport unit, but that would also allow for in addition to cutting down the amount of storage space required an enhanced ability to move volumes of these containers in an empty state to locations where they were required.

### BRIEF SUMMARY OF THE INVENTION

There is a need in the transport industry for easily stackable and movable freight transport containers that are adapted to existing size standards in the shipping industry. Thus, it is desirable to provide a freight container of maximal length, based on shipping industry standards that would be sturdy enough to handle a sufficiently large load of materials, but which would store in a relatively compact space for ease of storage and transport.

The present invention provides a novel freight container that is collapsible so that it can be readily transported and/or stored. In addition the present invention comprises a novel deck design that improves the rigidity of the transport container, and which provides advantages in improving the freight carrying capacity and stackability of the container. The present invention also provides folding support yokes that are adapted to improve the ease of loading and unloading of the container, and for the stacking of containers.

In a first aspect, the invention comprises a collapsible freight container which includes a freight deck for carrying freight, the freight deck having a first end, a second end, and opposing side edges. Attached to the freight deck are a first support yoke comprising two first yoke support posts each having a distal end and a deck end; and a first yoke crossmember, each first yoke support post connected at its distal end to the first yoke cross member and rotatably connected at its deck end to the freight deck, at matching points along the opposing side edges of the freight deck inwards from the first end thereof, such that the first support yoke from a transport position approximately perpendicular to the surface of the freight deck can pivot towards the center point of the freight deck, being a storage position. Also attached to the deck is a second support yoke comprising two second yoke support posts each having a distal end and a deck end; and a second yoke crossmember, each second yoke support post connected at its distal end to the second yoke cross member and rotatably connected at its deck end to the freight deck, at matching points along the opposing side edges of the freight deck inwards from the second end thereof, such that the second support yoke from a transport position approximately perpendicular to the surface of the freight deck can pivot towards the center point of the freight deck, being a storage position; and wherein each of the first and second support yokes can be supported and locked in their respective transport and storage positions; and wherein upon movement of each of the first and second support yokes to their storage positions the first and second yoke crossmembers will be approximately folded down flat upon the surface of the freight deck, being the storage condition of the container.

The attachment of the support yokes to the deck of the container is done in such a way that the yokes can be easily pivoted between the loading, transport and storage positions—the lightweight container has freight and shipping advantages, and can itself be stored or transported in a dense configuration. The first support yoke can be pivoted from its perpendicular transport position towards the first end of the freight deck, being a loading position; the second support yoke can be pivoted from its perpendicular transport position towards the second end of the freight deck, being a loading position; wherein upon movement of each of the first and second support yokes to their loading positions substantially all of the freight deck is exposed for unimpeded movement of payload upon the freight deck within the payload area defined by the dimensions of the freight deck and the inside of the support yokes when in their approximately perpendicular transport positions.

One or both of the support yokes can be extensible in length, to allow for maximum clearance of the payload envelope for top loading or to allow for adjustment of the height of the container. These can be made extensible by use of telescoping support post sections.

The points of attachment of the first and second support yokes along the opposing side edges of the freight deck are likely equidistant from the center of said opposing side edges. The collapsible freight container of Claim 1 wherein the distance between the points of attachment of the first support yoke and the second support yoke along the opposing side edges define the lifting length of the container, and the lifting length of the container is compatible with conventional intermodal container lifting equipment.

The top of the first support yoke and the top of the second support yoke most likely provide attachment points for use in the top lifting of the container, with transport container lifting equipment. The container, and the first and second support yokes could also be adapted to be connected to a second intermodal container stacked on top thereof when the first and second support yokes are in their transport positions. The stacked containers could all be those of the present invention, or the container could also be interchangeably stackable with other conventional intermodal containers. The collapsible freight container of the invention could also be adapted to be safely stacked, when its storage condition, with at least one similar container in its storage condition.

Either the first or second support yoke could be pivoted manually between the transport and storage positions. Alternatively the pivoting of either the first or second support yoke between the transport and storage positions could actuated mechanically by at least one of hydraulic, pneumatic, electric, or bias means.

Either the first or second support yoke could be pivoted manually between the loading, transport and storage positions. Alternatively the pivoting of either the first or second support yoke between the loading, transport and storage positions could actuated mechanically by at least one of hydraulic, pneumatic, electric, or bias means. At least one support strut might also be included connected to the first or second support yoke, to substantially prevent pivoting of the support yoke upon application of a load to the support yoke when the support yoke is in the transport position.

The freight deck of the collapsible freight container substantially resists flexing when the freight container is being lifted or stacked. The collapsible freight container could also include forklift guides by which the container can be lifted using a forklift.

The collapsible freight container could also include storage cutouts in the freight deck adapted to receive either support yoke in the storage position, or a plurality of loading cutouts in the freight deck adapted to receive either support yoke in the loading position.

The collapsible freight container might also include an end panel positioned at one or both of the first and second ends, said end panel extending upward from the freight deck and not exceeding the height of the support yokes. The end panels might include access doors, and could be pivotally connected to the freight deck along the edge of the freight deck in question. The end panels could be linked to the nearest support yoke, being a linked end panel, so that when the support yoke is moved between the storage, transport and loading positions the linked end panel will move in concert therewith, and wherein the linked end panel will lay approximately parallel and flat to the freight deck when the connected support yoke is in its storage position and will be approximately perpendicular to the freight deck when the connected support yoke is in its transport position. The linked end panel will be out of the way of the connected support yoke, which will in turn not impede the top loading up the freight deck, when that connected support yoke is in its loading position.

The container could have additional support yokes to strengthen the container during stacking, and might also include a payload cover to protect the load on the freight deck, such as a removeable tarp.

The bottom surface of the freight deck is adapted to engage a conventional intermodal shipping container when stacked thereon.

In addition to the collapsible shipping container itself, the invention also covers a method of storing collapsible freight containers including providing at least one collapsible freight container including: a freight deck for carrying freight, the freight deck having a first end, a second end, and opposing side edges; a first support yoke including two first yoke support posts each having a distal end and a deck end, and a first yoke crossmember, each first yoke support post connected at its distal end to the first yoke cross member and rotatably connected at its deck end to the freight deck, at matching points along the opposing side edges of the freight deck inwards from the first end thereof, such that the first support yoke from a transport position approximately perpendicular to the surface of the freight deck can pivot towards the center point of the freight deck, being a storage position; a second support yoke including two second yoke support posts each having a distal end and a deck end, and a second yoke crossmember, each second yoke support post connected at its distal end to the second yoke cross member and rotatably connected at its deck end to the freight deck, at matching points along the opposing side edges of the freight deck inwards from the second end thereof, such that the second support yoke from a transport position approximately perpendicular to the surface of the freight deck can pivot towards the center point of the freight deck, being a storage position; and wherein each of the first and second support yokes can be supported and locked in their respective transport and storage positions; and wherein upon movement of each of the first and second support yokes to their storage positions the first and second yoke crossmembers will be approximately folded down flat upon the surface of the freight deck, being the storage condition of the container; moving and locking the first and second support yokes into their storage positions, placing the at least one freight container in a storage configuration, being a collapsed freight container; and placing the at least one collapsed freight container in a storage location.

Stacking one or more containers using this method, the at least one collapsible freight container might be adapted for engagement of other freight containers in a stack when in its storage configuration.

In addition to the method of container stacking, there is also included a method for containerizing materials for transport using a collapsible freight container, the method including: providing a freight container including a freight deck for carrying freight, the freight deck having a first end, a second end, and opposing side edges; a first support yoke including two first yoke support posts each having a distal end and a deck end; and a first yoke crossmember, each first yoke support post connected at its distal end to the first yoke cross member and rotatably connected at its deck end to the freight deck, at matching points along the opposing side edges of the freight deck inwards from the first end thereof, such that the first support yoke from a transport position approximately perpendicular to the surface of the freight deck can pivot towards the center point of the freight deck, being a storage position; a second support yoke including two second yoke support posts each having a distal end and a deck end; and a second yoke crossmember, each second yoke support post connected at its distal end to the second yoke cross member and rotatably connected at its deck end to the freight deck, at matching points along the opposing side edges of the freight deck inwards from the second end thereof, such that the second support yoke from a transport position approximately perpendicular to the surface of the freight deck can pivot towards the center point of the freight deck, being a storage position; and wherein each of the first and second support yokes can be supported and locked in their respective transport and storage positions; and wherein upon movement of each of the first and second support yokes to their storage positions the first and second yoke crossmembers will be approximately folded down flat upon the surface of the freight deck, being the storage condition of the container; loading the materials to be transported onto the freight deck; and moving and locking the first and second support yokes into their upright transport positions, yielding the loaded collapsible freight container.

In this method, the first support yoke can be pivoted from its perpendicular transport position towards the first end of the freight deck, being a loading position; the second support yoke can be pivoted from its perpendicular transport position towards the second end of the freight deck, being a loading position; wherein upon movement of each of the first and second support yokes to their loading positions substantially all of the freight deck is exposed for unimpeded movement of payload upon the freight deck within the payload area defined by the dimensions of the freight deck and the inside of the support yokes when in their approximately perpendicular transport positions; the method further comprising moving the first and second support yokes into their loading positions before loading the materials to be transported onto the freight deck.

In this method, either support yoke could be extensible in height, and the method further comprises extending the support yokes to remove the yoke crossmembers from any impedance of top access to the freight deck, in advance of loading the freight deck. The final step in this method might be lifting the loaded collapsible freight container onto a conveyance; and transporting the freight container and materials using the conveyance.

There is also disclosed a method of stacking intermodal freight containers, the method comprising stacking a plurality of intermodal freight containers using conventional container lifting equipment, wherein at least one of the plurality of intermodal freight containers being stacked is a collapsible freight container in accordance with the present invention.

### BRIEF DESCRIPTION OF THE DRAWINGS

Preferred embodiments are provided in the accompanying detailed description which may be best understood in conjunction with the accompanying diagrams where like parts in each of the several diagrams are labeled with like numbers, and where:

FIG. 1 is a top schematic view of the freight deck of an embodiment of the collapsible freight container of the present invention, provided for the purpose of describing the dimensions and parts of the freight deck;

FIG. 2 is a side elevation of the collapsible freight container of FIG. 1;

FIGS. 3A through 3D are schematic drawings of the collapsible freight container of the present invention conceptually demonstrating the transport, storage and loading positions of the support yokes;

FIG. 4 is a side view of a collapsible freight container in accordance with the present invention with the support yokes folded out into the loading position, demonstrating the loading of the payload onto the freight deck;

FIG. 5 shows the container of FIG. 4 in a loaded position, and demonstrates the use of a container crane to lift same;

FIG. 6 shows the container of FIG. 4 demonstrating the folding of the support yokes and end panels into the storage position;

FIG. 7 is a perspective view of another embodiment of the collapsible freight container of the present invention;

FIG. 8 is a flow chart demonstrating one embodiment of a method of storage of a collapsible freight container in accordance with the present invention;

FIG. 9 is a flow chart demonstrating one embodiment of a method of storage of a collapsible freight container in accordance with the present invention;

FIG. 10 demonstrates a plurality of collapsible freight containers in accordance with the present invention folded into their storage position and stacked for storage;

FIG. 11 demonstrates a plurality of the collapsible freight containers of FIG. 6 folded into their storage position and stacked for storage;

FIG. 12 demonstrates one embodiment of a plurality of stacked intermodal freight containers including the container of the present invention; and

FIG. 13 is a flow chart demonstrating one embodiment of the method of containerization and transport of materials using the collapsible freight container of the present invention.

### DETAILED DESCRIPTION OF THE ILLUSTRATED EMBODIMENTS

The following narrative is intended to generally describe the operation of selected embodiments of the present invention, for the purpose of outlining or enabling its operation to those skilled in the art. Review of this information will, to those skilled in the art, also infer or disclose reasonable modifications or extensions of the described subject matter, all of which are also contemplated within the scope of the present invention. In the description, similar parts are marked throughout the specification and drawings with the same respect to reference numerals. The drawings are not necessarily to scale and in some instances or portions may have been exaggerated in order to more clearly depict certain features or elements of the invention.

### Payload Envelope:

There are two concepts which it is desired to illustrate for the purpose of outlining the utility and concept of the present invention. The first of these is the concept of the payload space or envelope within an intermodal-shipping container.

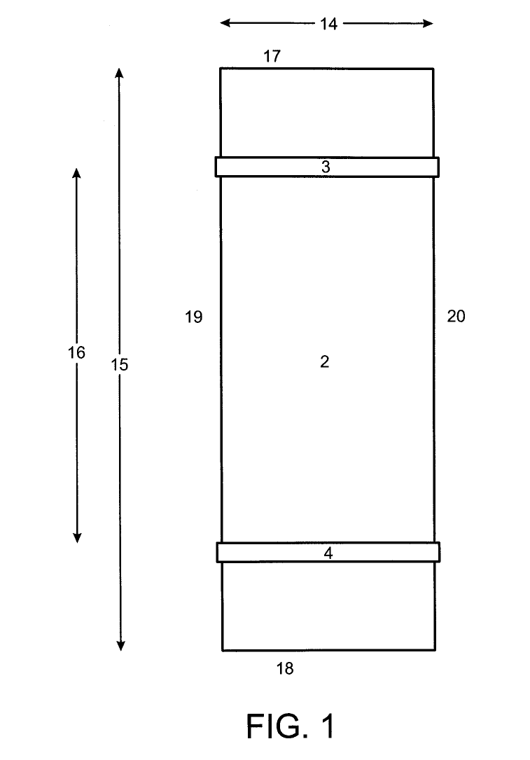

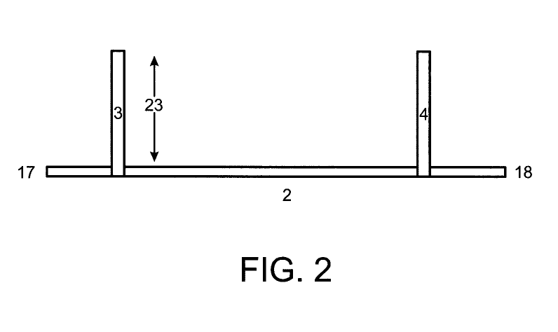

As outlined elsewhere above, the present invention is a collapsible shipping container which can be used in intermodal or other shipping applications and which has certain advantages in manufacture or use over the prior art including over conventional enclosed intermodal shipping containers. Referring to FIGS. 1 and 2 in this document, there are shown a top view and a side view of one embodiment of a collapsible shipping container in accordance with the present invention. The embodiment of the collapsible shipping container 1.

Referring first specifically to FIG. 1, there is shown a freight deck 2 in the top view, as well as the first and second ends of the freight deck being specifically marked 17, 18. As well, the opposing side edges of the freight deck are marked 19 and 20. In addition to the freight deck 2 the other key elements of the collapsible shipping container 1 of the present invention as are shown in this Figure are the support yokes 3, 4. The first support yoke 3 is a support yoke which is pivotally attached to the opposing side edges 19 and 20 of the freight deck in closer proximity to the first end 17 of the freight deck, and the second support yoke 4 is attached to reflective points on the opposing side edges 19 and 20 of the freight deck 2 in closer proximity to the second end of the freight deck 18. In terms of the overall dimensions of the load which could be transported using the container of the present invention, the maximum width dimension of the payload of this container is shown as dimension 14 on FIG. 1, and the maximum length of the payload is shown as dimension 15.

Referring to FIG. 2, there is shown a side view of the collapsible shipping container 1 which is demonstrated in FIG. 1 and the side view of FIG. 2 also demonstrates the maximum load height 23.

As will be discussed elsewhere herein in further detail one of the key elements of the present invention is that fact that the collapsible shipping container 1 of the present invention can be used interchangeably with conventional or pre-existing intermodal lifting equipment or facilities. One other key dimension of note is the lifting length 16 of the container which is also shown in FIG. 1. The lifting length 16 is the distance between the support yokes 3 and 4 and the lifting length 16 is contemplated specifically to be within the pre-defined range of usable lifting lengths 16 which might already be pre-existing with intermodal container lifting cranes, tractors and the like. The payload envelope of the container 1 is then demonstrated by the three dimensions 14, 15 and 23.

It will be understood by one skilled in the art that no particular or specific dimensions would be required in terms of the manufacture of the container 1 of the present invention beyond the desire to purpose build the container 1 of the present invention for use in various intermodal or other applications. For example, if the intermodal application in which the collapsible shipping container 1 of the present invention was primarily intended to be used contemplated 52-foot-long shipping containers which would be used on railcars and trailer decks, then it may be the case that the freight deck 2 would be manufactured such that the maximum load length 15 would be approximately 52 feet, simply so that the container 1 of the present invention could be used along with other similar containers. Container lifting length in intermodal applications is typically in the range of 40 feet, and so likely the lifting legnth 16 of the container would be 40 feet (i.e. the support yokes would be spaced approximately 40 feet apart and likely equidistantly inward of the ends of the deck 2). Continuing in intermodal applications there are also on occasion situations in which half-length containers are used in intermodal transport and it would also be possible to manufacture a half-length collapsible shipping container 1 in accordance with the present invention by again appropriately adjusting the dimensions of the various parts of the collapsible shipping container of the present invention. Dependent upon the length of the container 1 it may be necessary to make the support yokes 3 and 4 interlock or fold together in some way when they were down in the storage position, and this type of a modification again will be obvious to one skilled in the art and on that basis is contemplated within the scope hereof.

The support yokes 3 and 4 of the collapsible shipping container 1 of the present invention could be manufactured in varying heights dependent upon the type of load which it was desired to carry and the application or function in which the container 1 would be used. The shipping container 1 of the present invention could be manufactured in whatever necessary dimension to produce the desired payload envelope. It is also possible to make the shipping container 1 of the present invention adjustable in height by making the support yokes 3, 4 collapsible or extensible by telescoping sections or the like—producing support yokes which could be extended would also enable maximum clearance of the payload envelope when the container was being top loaded, and this is all disclosed and outlined in further detail below.

### Support Yoke Positions:

The next concept which it is desired to outline in further detail for the purpose of discussing the overall concept of the present invention is the positions of the support yokes 3 and 4 on the freight deck. To recap the key aspects or relevance of each support yoke, each yoke support post is connected at its distal end to the related yoke cross member and is repeatedly connected at its deck end to the freight deck, at matching points along the opposing side edges of the freight deck inwards from an end thereof, such that the support yoke from a transport position approximately perpendicular to the surface of the freight deck can pivot towards the center point of the freight deck, being a storage position, and/or could also pivot towards the closest end of the freight deck two open or remove the impediment to the payload envelope for top loading of the container.

In the most basic embodiments of the collapsible shipping container 1 of the present invention is a container 1 within which the support yokes 3 and 4 would be pivotally attached at each of their distal post ends to reflective points on either side edge 19 and 20 of the freight deck 2 such that they could pivot between an approximately perpendicular position to the freight deck 2, being a transport position, and an approximately parallel position laying on the top of or in proximity to the freight deck 2 towards the center point of the freight deck 2, being a storage position.

While we refer to an approximately parallel position for the storage position, the support yokes 3 and 4 in their storage position may not be quite parallel to the axis of the freight deck 2 if they were laying on top of the freight deck 2 in their storage position rather than being accommodated within cutouts within the freight deck 2 but it will be understood that the storage position of the support yokes 3 and 4 in either case, namely parallel with the axis of the freight deck 2 within necessary cut outs within the freight deck 2, or laying approximately flat on top of the freight deck 2 towards the center point of the freight deck 2, are both contemplated within the scope of the present invention. To most easily make the support yokes 3, 4 capable of lying flat on and in cutouts from the deck 2, the support posts of the yokes 3,4 might be mounted outside of the side edges of the deck 2, so that they could fold down adjacent and parallel to the outside edges of the deck 2, with only the crossmembers of the support yokes then needing to be accomodated to render a completely flat transport position.

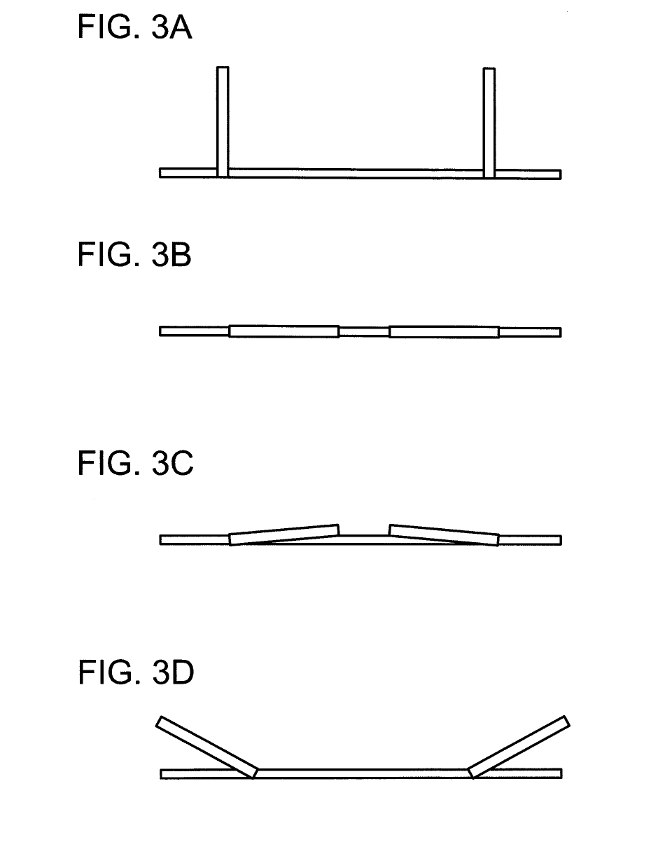

Referring to FIGS. 3A, 3B and 3C, the key positions of the support yokes 3 and 4 with respect to various embodiments of the collapsible shipping container 1 of the present invention are shown. Referring first to FIG. 3A, there is shown a side view of the embodiment of the shipping container of the present invention shown in FIGS. 1 and 2, where the support yokes 3 and 4 are in their upright and approximately perpendicular locked transport positions in relation to the freight deck 2. Support yokes 3 and 4 in this upright position define the top of the payload envelope and also provide the lifting points by which the freight deck 2 and the remainder of the container 1 of the present invention can be top lifted, or upon which additional containers can be stacked.

Referring next to FIG. 3B, the support yokes 3 and 4 have been folded down towards the center of the freight deck 2 to provide a flattened shipping container 1 in the storage position. In this particular case the support yokes 3 and 4 are accommodated in cutouts within the freight deck 2 or otherwise in such a way that the side posts of those yokes 4 and 3 can lie directly parallel to the side edge or axis of the freight deck 2.

Referring to FIG. 3C there is shown an alternate embodiment of the shipping container 1 in a storage position, where the support yokes 3 and 4 are folded down flat to the top of the freight deck 2 such that they lie nearly parallel but not quite parallel to the side edge and the axis of the container 1. Either such conceptual approach to the collapsibility of the freight container 1 of the present invention is contemplated within the scope hereof.

Basic embodiments of the collapsible container 1 of the present invention will involve support yokes 3 and 4 which in relation to the freight deck 2 have only the upright or perpendicular transport position, as shown in FIG. 3A, and a storage position such as is shown in FIGS. 3B and 3C. However in certain other embodiments of the collapsible freight container 1 of the present invention there is another position of the support yokes 3 and 4 which it is necessary to conceptually establish or define, being the loading position. In certain embodiments of the shipping container of the present invention in addition to being able to be locked in an approximately upright or perpendicular position in relation to the freight deck 2, and in a flattened storage position in relation to the freight deck 2, the support yokes 3 and 4 would also be capable of pivoting away from the center of the freight deck 2 towards their nearest ends of the freight deck, being the first end 17 in respect to the first support yoke 3 and being the second end 18 in respect to the second support yoke 4. By providing a outward loading position for the support yokes 3 and 4, it is possible to provide a collapsible shipping container 1 in accordance with the remainder of the present invention which also allows for the movement of the support yokes 3 and 4 entirely out of the way in respect of the payload envelope so that the container 1 could be top loaded by placement of the material in question directly onto the freight deck 2 without impedance by the support yokes 3 and 4, which once the payload was in place could then be pivoted back to their upright transport positions.

Referring to FIG. 3D there is shown one basic conceptual embodiment of the shipping container of FIGS. 1 and 2 in which case the support yokes 3 and 4 are shown to be pivoted out towards their respective ends of the freight deck 2 into a loading position, allowing for complete unimpeded access to the entire payload envelope of the shipping container 1 during top loading.

In certain embodiments it may be the case that cutouts would be provided within the freight deck 2 to allow for portions of the support yokes to completely stow therein and allow for the flattest most compact storage of the container 1. In addition to these storage cutouts which might accommodate the cross members of the support yokes, for example, it may also be the case that it was necessary to provide some other type of corresponding cutouts or apertures towards each end of the freight deck from the point of attachment of the support yokes, being loading apertures which would allow for the support yokes in certain embodiments to most completely fold out of the way of the payload envelope for the top loading of the container. In embodiments of the container of the present invention where the support yokes and the yoke support posts were attached rotatably along but outside of the side edges of the freight deck 2, loading cutouts would likely not be required but it will be understood by one skilled in the art that various types of openings or cutouts could be created or allowed within the remainder of the device to allow for its optimized use and all such modifications are contemplated within the scope of the present invention.

### General Overview:

Referring again further to the collapsible shipping container 1 which is shown in FIGS. 1 and 2, the general concept and operation of the collapsible shipping container 1 of the present invention can be illustrated. The collapsible shipping container 1 of the present invention in the embodiments shown in these Figures would have two and possibly three configurations during use—being the transport, storage and loading configurations shown in FIGS. 3A through 3D. The transport position of the collapsible shipping container 1 is the configuration of the container 1 wherein the first and second support yokes 3 and 4 respectively are in their upright or perpendicular position in relation to the freight deck 2. In this transport position, the collapsible shipping container 1 could be lifted and transported, either by lifting from the bottom using a forklift or other conventional means, or by lifting on the top by attachment of lifting means such as a crane, lifter or otherwise to the tops of the first and second support yokes 3 and 4. As outlined above, in the circumstance where the collapsible shipping container 1 of the present invention was going to be lifted onto a conveyance or into a stacking configuration using a crane or other conventional top-lifting intermodal lifting equipment, it is contemplated that the positioning of the first and second support yokes 3 and 4, and the lifting length 16 of the container 1 would be configured such that pre-existing or conventional top-lifting equipment which was already in use in intermodal transport applications could be used for this as well.

The second position into which each embodiment of the collapsible shipping container 1 of the present invention could be moved, at the heart of the present invention, is into the collapsed storage position. The collapsed storage position of the shipping container 1 is the position wherein the first and second support yokes 3 and 4 are folded down towards the center of the freight deck in such a way to collapse the container 1 into a minimal space configuration which is dense and approximately flat whereby it could be stacked for storage or could even be stacked for transport with multiple other containers on a trailer, train car or the like. The storage position of the support yokes 3 and 4 is demonstrated in FIGS. 3B and 3C, as outlined in further detail above.

In order to use the collapsed storage container 1 of the present invention to transport materials or equipment, the collapsed container 1 in the storage position as shown in FIGS. 3B or 3C could be moved into the loading or transport position shown in FIG. 3A by basically erecting the support yokes 3 and 4 into their approximately perpendicular transport positions in relation to the freight deck 2 and locking them there. By virtue of the fact that there is effectively a open space in the center of the support yokes 3 and 4 the load of the container 1 can be placed within the confines of those yokes 3 and 4 and the yokes then used to define the outer dimension of the load and the container 1 in such a way that additional containers could be stacked on top of this container 1 by stacking those additional containers on top of the support yokes 3 and 4.

The tops of the support yokes 3 and 4 could be adapted firstly to allow for the attachment of top-lifting equipment such as a crane or other lifting tractor or the like. Various types of brackets or other attachment means by which a crane could grab onto the container by attachment of itself to those support yokes 3 and 4 are contemplated within the scope hereof. As well and similarly, either the same attachment points or others along the top of the first and second support yokes 3 and 4 could be used to render the collapsible shipping container 1 of the present invention stackable, so long as the support yokes 3 and 4 themselves were placed in appropriate positions in relation to the freight deck 2 such that they could accommodate the attachment or the engagement of another similar shipping container or even another conventional intermodal container of box or other type thereon.

Finally, in terms of the adaptability of the collapsible shipping container 1 of the present invention for stackability in transport applications, in addition to the tops of the support yokes 3 and 4 being adapted to allow for top lifting or stacking, the bottom of the freight deck 2 could also be adapted to allow for the stacking of the collapsible freight container 1 of the present invention on top of other similar containers with mating engagement means on their support yokes 3 and 4 or again as well the freight deck could also include attachment points whereby the collapsible shipping container 1 of the present invention could be stacked on top of additional conventional intermodal shipping containers of box, tank or other types.

The specific nature of those engagement means or attachment means to provide for the attachment of lifting equipment or the engagement of the collapsible shipping container 1 of the present invention with additional containers in a stacked configuration will be understood by those skilled in the art and the specific nature of those are all contemplated within the scope of the present invention.

### Clearing the Payload Envelope for Top Loading:

One of the basic benefits of the collapsible shipping container 1 of the present invention, in addition to the fact that the container 1 will be lighter weight than its conventional contemporaries even for some conventional shipping applications as a result of the fact that it does not include metal walls, is the fact that there would be a fair degree of flexibility in loading these containers dependent upon the type of load which was desired to be placed thereon since for example it would even be possible with the container in the transport position to drive on and drive off of the freight deck 2 with a forklift or other loading equipment to place a load on the freight deck 2. A crane or other top loading device could also be used to load the payload onto the freight deck 2. Conventional chain or strap tiedowns etc. could be used to anchor the load once placed on the freight deck 2. Also in the case of certain embodiments of the collapsible shipping container 1 of the present invention, where an end panel was used which would in many ways simulate the end or panel of a conventional shipping container and the end panel could either be folded out of the way or there was an openable door extending therethrough, the door could be opened or the panel folded down even as a ramp so that there could be again a forklift or other loading equipment used to load the payload onto the container 1 from the end rather than from the side. The flexibility of different loading options with the collapsible shipping container 1 of the present invention will be understood.

One of the additional primary benefits of the design of the collapsible shipping container 1 of the present invention is the ability in certain embodiments of the container 1 to fold the support yokes 3 4 completely out of the way so that there was an unimpeded top loading payload envelope, allowing for the top loading of a full-length payload onto the container.

### Extensible Support Yokes:

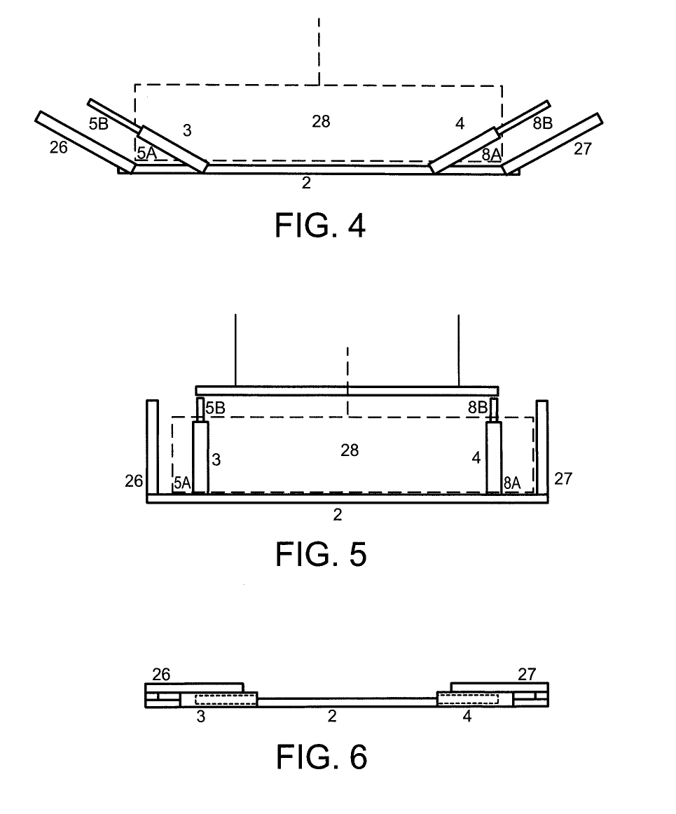

FIGS. 4 through 6 demonstrate another embodiment of the collapsible shipping containers 1, by which we can more specifically demonstrate some of these added features. FIG. 4 demonstrates a collapsible shipping container 1 in accordance with the present invention with the support yokes 3, 4 folded into their loading positions, whereas FIG. 5 shows the containers 1 in the transport position [and also demonstrates a lifting crane 30 attached thereto]. Finally FIG. 6 demonstrates this particular embodiment of the shipping container 1 of the present invention in a collapsed storage position, where the support yokes are in a different configuration in their folded down position and the end panels which are shown are folded down on top of the support yokes again into a flat storage position.

Referring to FIG. 4 more specifically there is shown a collapsible shipping container 1 in accordance with the present invention. The freight deck 2 has two support yokes 3, 4 attached pivotally thereto on opposing sides of the freight deck 2 such that they can pivot between storage, transport and loading positions. Also shown in this particular embodiment in addition to the support yokes 3, 4 are to end panels on the container 1, shown at 26 and 27. The end panels, which can be seen in a vertical transport position in FIG. 5, would allow for the definition of a more conventional safety zone around the payload and could also as will be discussed elsewhere herein be fitted with doors such that the container 1 when in a transport position and in a stack of intermodal containers would allow for protection of the payload and access thereto in a conventional fashion. The end panels 26, 27 can be seen to fold out of the way into a loading position similar to that of the support yokes 3, 4.

In addition to demonstrating the addition of pivotally attached end panels 26, 27 to the collapsible shipping container of the present invention, FIGS. 4 through 6 also demonstrate another key aspect of the present invention which is that of the extensible support yokes. Each of the support yokes 3 and 4 as outlined elsewhere herein would comprise two support posts and a cross member. It is specifically anticipated that the support posts of these support yokes 3, 4 could be made in a way that they would be extensible in length so let either the finished height of the container 1 in the transport position could be adjusted by adjusting the length of those yokes, or the other key benefit to an extensible support yoke is that dependent upon the point of attachment of the support yoke along the edge of the freight deck, it may be necessary to move the cross member associated with that support yoke out of the way of the top loading payload. For example if the dimensions of the support yokes 3, 4 were such that their geometry in the open loading positions did not have their cross members extended out beyond the ends of the freight deck 2 it may be desirable to lengthen the support yokes 3, 4 to get the cross members out of the way of the top loading payload, and the support yokes 3, 4 could then be collapsed back into their regular transport links and position when the payload was in position on the freight deck. In this particular case, the support yokes 3, 4 which are shown in these Figures are rendered extensible in length by the use of telescoping support post sections, which are shown as 5A and 5B in respect of the first support yoke 3 and are shown as 8A and 8B in respect of the second support yoke 4. FIG. 4 shows the support yokes 3, 4 extended into a longer length to get out of the payload envelope during loading, while FIG. 5 shows the support yokes 3, 4 locked in a shorter transport position although still demonstrates the telescoping or extensible nature of those support yokes. Finally FIG. 6 demonstrates the complete collapsible nature of those support posts by demonstrating the complete compartmentalization of the Interior telescoping sections inside of the exterior telescoping sections, with the support yokes 3, 4 collapsed into their parallel and flat positions in relation to the freight deck 2.

Both the end panels 26, 27 and the support yokes 3, 4 might also include some type of bracing which was hingably attached to the deck 2 to strengthen those components when held likely primarily in their vertical transport position. It is also specifically contemplated that the end panels and their adjacent support yokes could be specifically linked together in a fashion that they would fold between their various positions in unison. Development of a mechanical linkage which would accomplish this objective would be understood by one skilled in the art and all such mechanical linkages are contemplated within the scope of the present invention.

Is also specifically contemplated and anticipated that certain embodiments of the collapsible freight container 1 of the present invention would in addition to actually having a linkage between pivotally attached end panels and pivotally attached support yokes as outlined herein allowing for the movement in unison of those items in a somewhat automated or streamlined fashion between the various loading, transport and storage positions, would also include some type of a power mechanism such as a hydraulic ram or the like by which the container could be most quickly collapsed without the need for any significant amount of manual labor—for example if a hydraulic ram was used to pivot the components of the container 1 between the loading, transport and storage positions, and an intermodal tractor or crane which included a hydraulic system could be quickly connected to move the container 1 between its various positions.

In FIG. 6 is shown one way by which the pivoting end panels 26, 27 could fold flat on top of the collapsed support yokes 3, 4. The support yokes in this case appear to fold nearly perpendicular and flat in relation to the freight deck 2—in order to accomplish this the cross members of each of the two support yokes would need to fold into a cutout or some other type of an opening in the freight deck 2. The end panels 26 and 27 are then shown in this Figure to be hinged slightly above the deck 2, which allows them to hinge flatly down on top of the yokes. If the support yokes alternatively were completely integral within the deck 2 when in their storage positions the pivotally attached end panels could simply fold down flat on top of the freight deck 2 and still accomplish the same objective of a flat folded container 1 when in its storage position.

FIG. 4 shows the loading of the payload 28 onto the open freight deck 2 using a crane or the like. A conventional intermodal crane is shown at reference 30. As outlined elsewhere herein various types of cranes or top lifting tractors could be used, and dependent upon the type of lifting equipment which was going to be used the support yokes might be modified in their position along the side edges of the freight deck 2. As well, forklift or other bottom loading apparatus could also be used to lift and/or stack the loaded or collapsed containers 1.

### Actuation of the Support Yokes:

As outlined above, the support yokes 3, 4, and the pivotally attached end panels if present in a particular embodiment and if linked to the support yokes 3, 4, could be mechanically actuated between their various positions. It is specifically contemplated for example that the use of a hydraulic ram or a hydraulic system on the container 1 could move the support yokes and end panels, separately or in linkage or unison, between their various positions. While we speak specifically of a hydraulic actuator here, it would also be possible to conceive of other types of mechanical actuation for these components and all such methods are contemplated within the scope of the present invention. The key to successfully mechanically actuating the support yokes and end panels in tandem between their various positions for loading, transport and storage, will be coming up with the proper mechanical linkage between the support yokes, the mechanical actuator and the end panels.

Creation of hinges and mechanical linkages such as this will be understood by one skilled in the art and all such linkages are also contemplated within the scope hereof. Basically if the components of the containers 1 were mechanically actuated it may provide for quicker market adoption of the product of the present invention since the product would be safer to use for the operator and would require less operator or labor assistance to move it between its various positions.

### Strengthening of the Freight Deck:

One of the key aspects of the present invention which also distinguishes the collapsible shipping container 1 of the present invention from previous efforts in the same area in the prior art is the fact that the freight deck 2 has been strengthened in such a way that it will not flex when the container 1 is lifted or stacked. Particularly where the container 1 is being top lifted it is necessary to ensure that the freight deck 2 will not flex or bend to any significant degree when the container 1 is lifted so as to not cause the support yokes 3 and 4 to move at their top attachment points outside of a predefined acceptable range of movement within which they could still be properly attached to the conventional top lifting intermodal container transport equipment. If the support yokes 3 and 4 at their distal ends move too far towards the center of the freight deck 2 when the loaded container 1 is lifted, by virtue of a loaded freight deck 2 with weight in the center thereof developing a bow or a bend therein, the attachment points for those support yokes 3 and 4 may move too far out of their predefined acceptable positions and if they move outside of a certain tolerance zone the attachment of the container 1 to the lifting crane or the like may be compromised or weakened.

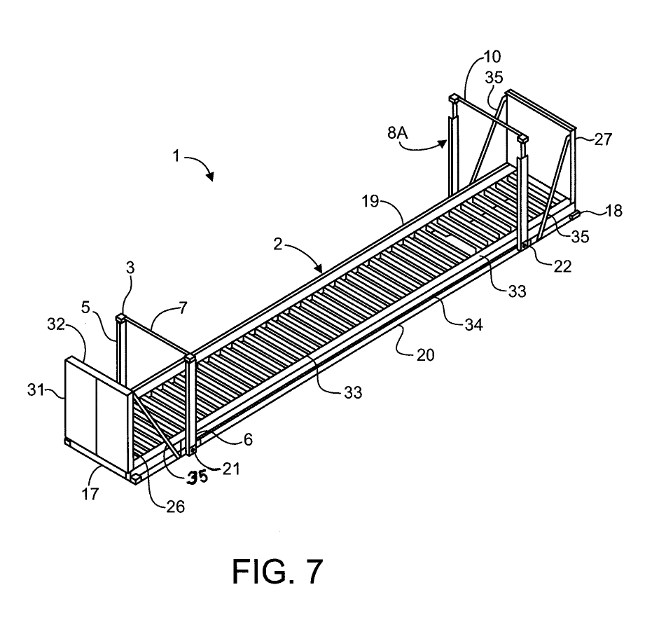

There will be many ways of strengthening the freight deck 2 to minimize the flexibility in the freight deck 2 and provide the most rigid support structure possible for the remainder of the container 1 and the freight load thereon, without adding significant or inefficient amounts of weight to the completed manufactured container 1. One means of doing this which is particularly contemplated is to provide side members to the freight deck 2 which have an arcuate upper edge profile which will result in enhanced strength of the side members on the freight deck 2 minimizing bending when the container 1 is lifted. We refer to the embodiment of the collapsible shipping container of the present invention shown in FIG. 7 to demonstrate this. The edge beams 34, each of which forms one of the side edges 19, 20 of the freight deck 2, can be seen to have this arcuate upper profile in this Figure. It will be understood that there other means of strengthening or minimizing the bow or flex in a listing and freight context such as this and within the context of the present invention those are contemplated within the scope hereof as well. Also shown in the embodiment of FIG. 7 are a plurality of deck cross members 33 which strengthening the freight deck 2 further.

Referring briefly to a couple of other aspects of the embodiment shown in FIG. 7, there are shown doors 31 in the end panel 26. It will be understood that doors could be present in end panel 27 as well. Also shown in this Figure are support struts 35 for the end panel 27 and 26. It will also be understood that similar support strut and could be presented in certain embodiments for the support yokes as well. Finally, the second support yoke is shown to be slightly extended, by the extension of telescoping post sections 8A and 8B.

If the provision of side members to a freight deck 2 with an arcuate upper edge profile onto which a freight bearing surface of the freight deck 2 is attached yields an arcuate freight bearing surface which is not appropriate for certain loading requirements another option would be to provide these side members with an arcuate upper edge profile for the purpose of providing added rigidity to the container 1. Providing for the attachment of the freight bearing surface of the freight deck 2 along the inside of those side members, so that a planar surface could be provided. It will be understood that both such approaches are explicitly contemplated within the scope of the present invention as well as any other methods which will be obvious to one skilled in the art which results in the strengthening of the freight deck 2 in such a way that the bending our flexibility of the freight deck 2 when loaded and top lifted is minimized and all such modifications or additions to the freight deck 2 of a collapsible shipping container 1 otherwise in accordance with the invention outlined herein are contemplated within the scope of the present invention as well.

### Covering Loaded Freight:

It is contemplated that the collapsible freight container 1 of the present invention could optionally include a removable and lightweight cover which would allow for the protection of the payload loaded on the container 1 from the elements without adding significant transportation weight to the device, and by making the container 1 collapsible and the covering removable, the removal of the cover would still allow for the collapsible storage of the container 1. The addition of a covering such as a tarp or some other type of a removable lightweight product will be understood by those skilled in the art and all such modifications or enhancements to the general concept of the collapsible freight container 1 are contemplated within the scope hereof.

### Collapsing Containers for Storage:

One of the key elements of the present invention is the fact that the collapsible shipping container 1 of the present invention can be collapsed for storage. By collapsing the container 1 for storage it can be reduced to a minimum space configuration, as well as potentially being stackable with other similar collapsed containers to allow for denser storage of quantities of empty containers numeral one in accordance with the present invention.

Conceptually what is done to place the container 1 of the present invention into its storage position is to fold the support yokes 3 and 4 down to be approximately parallel with the freight deck, as outlined in further detail with respect to the storage position of the container above.

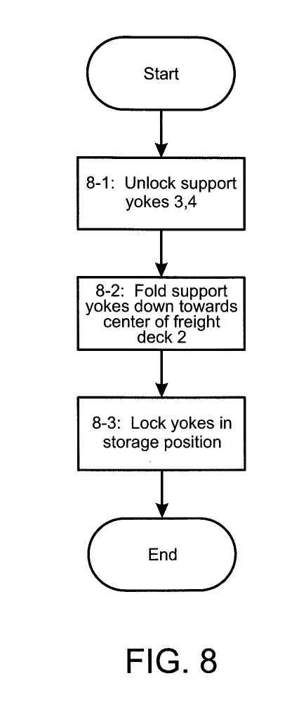

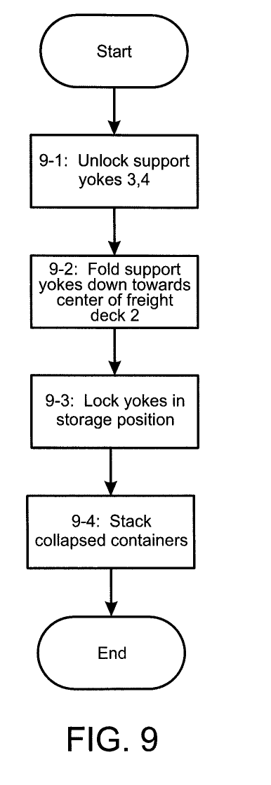

FIGS. 8 and 9 demonstrate two flowcharts of the method of collapse of the shipping containers of the present invention for storage in a minimized space storage configuration, as well as the stacking of multiple collapsed containers in accordance with the present invention for minimum space storage of multiple such containers. Referring first to FIG. 8, there is shown a flow chart of one embodiment of the method of conversion of the collapsible shipping containers 1 of the present invention from a transport to a storage position.

The first step in storing the collapsible shipping container 1 of the present invention from its transport figuration is to unlock the support yokes 3 and 4 from their locked upright transport positions approximately perpendicular to the freight deck 2, being the transport position. The precise means of unlocking the support yokes 3 and 4 will depend upon the nature of the locking hardware and the remainder of the apparatus but the unlocking of the support yokes 3 and 4 is shown at the first step in this flow chart, 8-1.

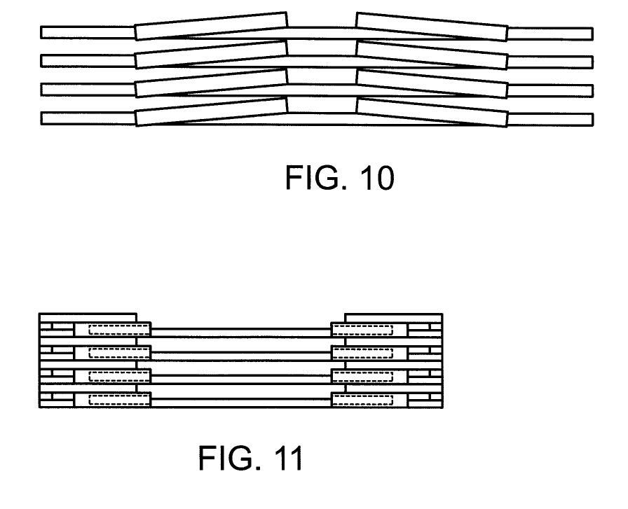

The next step which is shown in FIG. 8 is the actual folding down of the support yokes 3 and 4 from the transport to the storage positions wherein they are approximately parallel to the freight deck 2 with the distal ends of the support yokes folded towards the center of the freight deck 2. This step in the process is shown at 8-2. At this point the shipping container 1 is folded into an approximately flattened storage condition. The final step in completing the storage of the container 1 as is shown in the flow chart of the process of FIG. 10 is to lock the support yokes 3 and 4 in their folded flat storage positions. It is anticipated that some type of a locking mechanism may be incorporated into the apparatus to allow for the locking of the support yokes 3 and 4 into their storage positions when folded down, although it will also be understood that in many embodiments of the apparatus and method of the present invention it may not be necessary to lock the support yokes 3 and 4 into their flattened storage positions as it may be desirable to simply leave them freely flattened and not require a locking mechanism. Either approach is explicitly contemplated herein.

Referring to FIG. 9 momentarily, the first three steps of the process of folding down the collapsible shipping containers 1 of the present invention from the transport to a storage condition are shown, the same as those in FIG. 10. There is added to this figure, in addition to the same steps 9-1 through 9-3, an additional step 9-4 which represents the stacking of multiple storage configured shipping containers 1 of the present invention into a stack of collapsed containers which can be stored together in a dense and minimized space configuration. The stacking of those collapsed containers could be done using numerous types of lifting equipment. Where the containers 1 of the present invention were provided either on their top or bottom surfaces with engaging means to allow for the safe engagement of stacked containers, the stacking of the containers would comprise lifting each of the containers to be stacked into position over the one below it and engaging those containers together in a safe way such that they could rest together in their stored minimum space configuration.

For the sake of demonstration of the stackability of the collapsed storage containers, we reference FIGS. 10 and 11 which demonstrate four collapsible shipping containers 1 of the present invention stacked into a minimum space storage configuration. Each of those containers 1 is in its own storage position with the support yokes 3 and 4 folded down to an approximately parallel position in relation to the freight deck 2.

### Stacking Erected Containers:

One of the aspects of the collapsible shipping container 1 of the present invention which is desirable is the stackability of the containers 1 when in their erected transport positions. As is the case with other intermodal containers, the collapsible shipping containers 1 would likely be manufactured of similar shape and dimension to interface with other types of intermodal shipping containers which were also available, so as to make the collapsible shipping containers 1 most broadly usable and applicable in various shipping applications.

The container 1 of the present invention would, it is understood, be of sufficient strength to allow for the stacking of additional containers 1 on top thereof so that they could be stacked in a dense configuration for storage when they were loaded. Even for example in railroading applications, it is quite often the case that two and sometimes three shipping containers can be stacked on top of each other in a single intermodal railcar in a dense transport configuration, and the ability to stack the collapsible shipping containers 1 of the present invention in this way is desired.

As has been mentioned elsewhere in this specification, various modifications could be made both to the distal ends of the support yokes 3, 4 as well as to the bottom of the freight deck 2 of the collapsible shipping container 1 to allow for the collapsible shipping container 1 when stacked to engage in a lockable or safe fashion another shipping container 1 either stacked on top of or below that container 1.

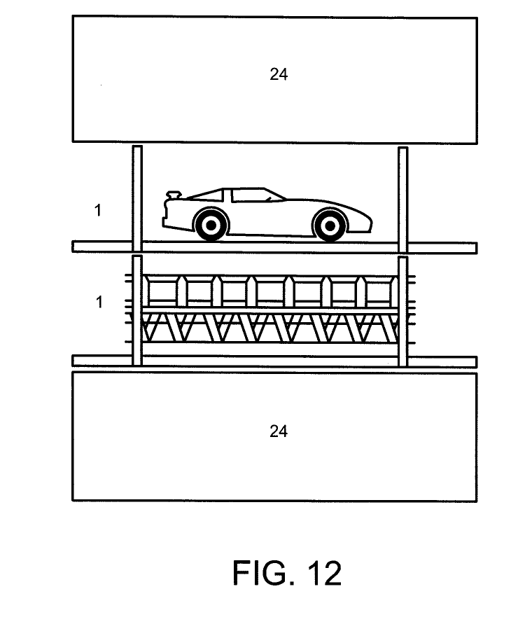

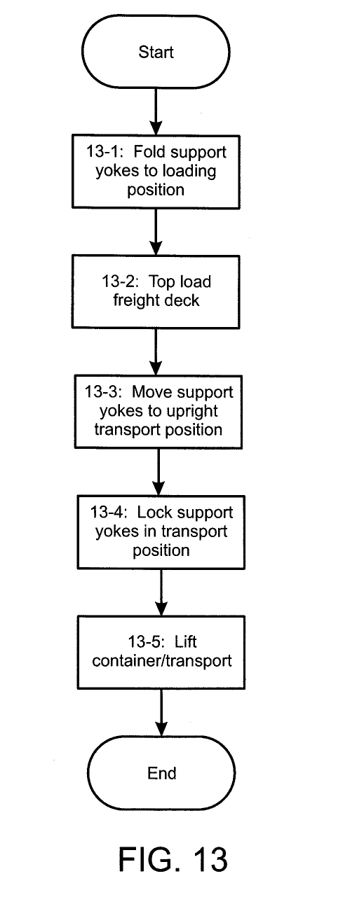

Referring to FIG. 12 for demonstration purposes there is shown a stack of intermodal shipping containers, including two shipping containers 1 of the present invention and two conventional intermodal shipping containers 24. Provided that the support yokes 3 and 4 were manufactured of sufficient strength to support the top loading, the collapsible shipping containers 1 of the present invention when in their transport position could be stacked quite high and would thus be usable and desirable for use in intermodal shipping yards and conventional intermodal shipping applications. Referring to this Figure, there are shown a total of four shipping containers in a stack, and the engagement of the containers 1 and 24 to each other in that stack can be seen in this Figure. The specific type of engaging means which would be used on the top of the support yokes 3 and 4 or on the bottom of the freight deck 2 could vary dependent upon the nature of the other services or devices which it was desired to engage with the containers 1—for example it may be the case that either the same or different engagement means will be used on the container 1 to allow it to engage other containers in a stack such as is shown in FIG. 13, or to engage either a trailer chassis or a rail car.

### Interoperability in Intermodal Service:

One of the primary aspects of the collapsible shipping container 1 of the present invention is that it is explicitly contemplated that the container 1 would be, in addition to collapsible and having its other features outlined herein, interchangeable in intermodal freight service both in terms of its dimensions as well as its ability to engage and stack with other intermodal shipping containers.

In order to ensure the interoperability of the collapsible shipping container 1 of the present invention with other conventional intermodal containers and transport methods and equipment, the collapsible shipping container 1 of the present invention can be adapted such that the tops of the shipping yokes 3 and 4 can engage another shipping container, either being another collapsible shipping container 1 of the present invention or another conventional intermodal shipping container, when stacked on top thereof. In addition to adapting the tops of the collapsible shipping container 1 of the present invention to allow for stacking more containers on top thereof, the bottom of the freight deck 2 of the shipping container 1 would also be adaptable so as to properly engage another collapsible shipping container 1 of the present invention or another conventional shipping container when it was stacked on top thereof. Similarly, in addition to modification of the top and bottom surfaces of the collapsible shipping container 1 of the present invention to allow for the stacking of the container 1 with other similar containers or other conventional intermodal containers, the container 1 would also be adaptable on its top or bottom surfaces of either the support yokes 3 and 4 or the freight deck 2 so that it could be properly stacked and engaged upon a transport chassis, being a semitrailer, rail car or the like.

In addition to providing the possibility of being safely stacked either on a transport chassis or with other containers, the collapsible shipping container 1 of the present invention would also be, as outlined in detail elsewhere herein, capable of being picked up and/or moved using conventional or pre-existing intermodal container picking or transport equipment such as cranes, forklifts, tractors or the like. Adaptation of the freight deck 2 or the top surfaces of the support yokes 3 and 4 to allow for the pickup and movement of the container 1 on this basis are also contemplated explicitly within the scope of the present invention.

### Method of Loading Payload:

The final aspect of the present invention which is contemplated to be within the scope hereof is the method of containerization and transport of freight using a collapsible shipping container such as that outlined herein. Referring to FIG. 13 there is shown a flow chart of a method of containerization and transport of freight using a collapsible shipping containers numeral one in accordance with the present invention. Specifically, the embodiment of the collapsible shipping containers numeral one which would specifically be contemplated within the scope of this particular flow chart would be an embodiment in which the support yokes folded out to a transport position to clear the payload envelope. In that circumstance, shown at step 13-1, the first step in the method would be to move the support yokes into their loading positions which would typically comprise unlocking them from being held in their approximately perpendicular transport positions and then either manually or mechanically actuating them into their loading positions away from the center of the deck 2. In the circumstance where the support yokes were extensible in length and that was required in order to clear the payload envelope that would also comprise a portion of this step.

Once the support yokes have been moved into their loading positions and the freight deck 2 was a unimpeded it could be top loaded, shown at step 13-2. Following loading of the payload onto the freight deck 2, the support yokes would be moved and locked back into their approximately perpendicular transport positions, shown at 13-3 and 13-4. Subject to any anchorage of the payload or the like, following the positioning of the support yokes back into their transport position, the container could be lifted or transported.

The previous description of the disclosed embodiments is provided to enable any person skilled in the art to make or use the present invention. Various modifications to those embodiments will be readily apparent to those skilled in the art, and the generic principles defined here in may be applied to other embodiments without departing from the spirit or scope of the invention is described. Thus, the present invention is not intended to be limited to only the exemplary embodiments shown herein, but is to be accorded the full scope consistent with the claims, wherein in reference to an element in the singular such as by use of the article “a” or “an” is not intended to mean “one and only one” unless specifically so stated, but rather “one or more.” All structural and functional equivalence to the elements of the various embodiments described throughout the disclosures that are known or may later come to be known to those of ordinary skill in the art are intended to be encompassed by the elements of the claims. Moreover nothing disclosed herein is intended be dedicated to the public regardless of whether such disclosure is explicitly recited in the claims.

1. A collapsible freight container comprising:
a freight deck for carrying freight, the freight deck having a first end, a second end, and opposing side edges;
a first support yoke comprising:
two first yoke support posts each having a distal end and a deck end; and
a first yoke crossmember,
each first yoke support post connected at its distal end to the first yoke cross member and rotatably connected at its deck end to the freight deck, at matching points along the opposing side edges of the freight deck inwards from the first end thereof, such that the first support yoke from a transport position approximately perpendicular to the surface of the freight deck can pivot towards the center point of the freight deck, being a storage position;
a second support yoke comprising:
two second yoke support posts each having a distal end and a deck end; and
a second yoke crossmember,
each second yoke support post connected at its distal end to the second yoke cross member and rotatably connected at its deck end to the freight deck, at matching points along the opposing side edges of the freight deck inwards from the second end thereof, such that the second support yoke from a transport position approximately perpendicular to the surface of the freight deck can pivot towards the center point of the freight deck, being a storage position;
wherein each of the first and second support yokes can be supported and locked in their respective transport and storage positions; and
wherein upon movement of each of the first and second support yokes to their storage positions the first and second yoke crossmembers will be approximately folded down flat upon the surface of the freight deck, being the storage condition of the container.

2. The collapsible freight container of claim 1 wherein:
the first support yoke can be pivoted from its perpendicular transport position towards the first end of the freight deck, being a loading position; and
the second support yoke can be pivoted from its perpendicular transport position towards the second end of the freight deck, being a loading position;
wherein upon movement of each of the first and second support yokes to their loading positions substantially all of the freight deck is exposed for unimpeded movement of payload upon the freight deck within the payload area defined by the dimensions of the freight deck and the inside of the support yokes when in their approximately perpendicular transport positions.

3. The collapsible freight container of claim 2 wherein either support yoke is extensible in height.

4. The collapsible freight container of claim 3 wherein the support posts of the extensible support yoke comprise lockable telescoping sections.

5. The collapsible freight container of claim 1 wherein the points of attachment of the first and second support yokes along the opposing side edges of the freight deck are equidistant from the center of said opposing side edges.

6. The collapsible freight container of claim 1 wherein the distance between the points of attachment of the first support yoke and the second support yoke along the opposing side edges define the lifting length of the container, and the lifting length of the container is compatible with conventional intermodal container lifting equipment.

7. The collapsible freight container of claim 1 wherein the top of the first support yoke and the top of the second support yoke provide attachment points for use in the top lifting of the container.

8. The collapsible freight container of claim 1 wherein each of the first and second support yokes are adapted for lifting with transport container lifting equipment.

9. The collapsible freight container of claim 1, wherein the first and second support yokes are adapted to be connected to a second intermodal container stacked on top thereof when the first and second support yokes are in their transport positions.

10. The collapsible freight container of claim 1 wherein the second intermodal container is a second collapsible freight container in accordance with claim 1.

11. The collapsible freight container of claim 1 wherein the second intermodal container is a conventional intermodal freight container.

12. The collapsible freight container of claim 1 wherein the container is adapted to be safely stacked, when its storage condition, with at least one similar container in its storage condition.

13. The collapsible freight container of claim 1, wherein either the first or second support yoke is pivoted manually between the transport and storage positions.

14. The collapsible freight container of claim 1, wherein the pivoting of either the first or second support yoke between the transport and storage positions is actuated mechanically by at least one of hydraulic, pneumatic, electric, or bias means.

15. The collapsible freight container of claim 2, wherein either the first or second support yoke is pivoted manually between the loading, transport and storage positions.

16. The collapsible freight container of claim 2, wherein the pivoting of either the first or second support yoke between the loading, transport and storage positions is actuated mechanically by at least one of hydraulic, pneumatic, electric, or bias means.

17. The collapsible freight container of claim 1, wherein the freight deck substantially resists flexing when the freight container is being lifted or stacked.

18. The collapsible freight container of claim 1 further comprising forklift guides by which the container can be lifted using a forklift.

19. The collapsible freight container of claim 1, further comprising storage cutouts in the freight deck adapted to receive either support yoke in the storage position.

20. The collapsible freight container of claim 1, further comprising a plurality of loading cutouts in the freight deck adapted to receive either support yoke in the loading position.

21. The collapsible freight container of claim 1, further comprising at least one support strut connected to the first or second support yoke, to substantially prevent pivoting of the support yoke upon application of a load to the support yoke when the support yoke is in the transport position.

22. The collapsible freight container of claim 1 further comprising an end panel positioned at at least one of the first and second ends, said end panel extending upward from the freight deck and not exceeding the height of the support yokes.

23. The collapsible freight container of claim 22 comprising an end panel positioned at each of the first and second ends, each end panel extending upward from the freight deck and not exceeding the height of the support yokes.

24. The collapsible freight container of claim 22, wherein at least one end panel further comprises an access door.

25. The collapsible freight container of claim 22, wherein the at least one end panel is pivotally connected to the freight deck along the edge of the freight deck in question.

26. The collapsible freight container of claim 25, wherein the at least one end panel is linked to the nearest support yoke, being a linked end panel, so that when the support yoke is moved between the storage, transport and loading positions the linked end panel will move in concert therewith.

27. The collapsible freight container of claim 26 wherein the linked end panel will lay approximately parallel and flat to the freight deck when the connected support yoke is in its storage position.

28. The collapsible freight container of claim 26 wherein the linked end panel will be approximately perpendicular to the freight deck when the connected support yoke is in its transport position.

29. The collapsible freight container of claim 26 wherein the linked end panel will be out of the way of the connected support yoke, which will in turn not impede the top loading up the freight deck, when that connected support yoke is in its loading position.

30. The collapsible freight container of claim 1 further comprising additional support yokes to strengthen the container during stacking.

31. The collapsible freight container of claim 1 further comprising a payload cover to protect the load on the freight deck.

32. The collapsible freight container of claim 31 wherein the payload cover is a removable tarp.

33. The collapsible freight container of claim 1 wherein the bottom surface of the freight deck is adapted to engage a conventional intermodal shipping container when stacked thereon.

34. A method of storing collapsible freight containers, the method comprising:
providing at least one collapsible freight container comprising:
a freight deck for carrying freight, the freight deck having a first end, a second end, and opposing side edges;
a first support yoke comprising:
two first yoke support posts each having a distal end and a deck end; and
a first yoke crossmember,
each first yoke support post connected at its distal end to the first yoke cross member and rotatably connected at its deck end to the freight deck, at matching points along the opposing side edges of the freight deck inwards from the first end thereof, such that the first support yoke from a transport position approximately perpendicular to the surface of the freight deck can pivot towards the center point of the freight deck, being a storage position;
a second support yoke comprising:
two second yoke support posts each having a distal end and a deck end; and
a second yoke crossmember,
each second yoke support post connected at its distal end to the second yoke cross member and rotatably connected at its deck end to the freight deck, at matching points along the opposing side edges of the freight deck inwards from the second end thereof, such that the second support yoke from a transport position approximately perpendicular to the surface of the freight deck can pivot towards the center point of the freight deck, being a storage position;
wherein each of the first and second support yokes can be supported and locked in their respective transport and storage positions; and
wherein upon movement of each of the first and second support yokes to their storage positions the first and second yoke crossmembers will be approximately folded down flat upon the surface of the freight deck, being the storage condition of the container;
moving and locking the first and second support yokes into their storage positions, placing the at least one freight container in a storage configuration, being a collapsed freight container; and
placing the at least one collapsed freight container in a storage location.

35. The method of claim 34, further comprising stacking at least one additional collapsed freight container.

36. The method of claim 35 wherein the at least one collapsible freight container is adapted for engagement of other freight containers in a stack when in its storage configuration.

37. A method for containerizing materials for transport using a collapsible freight container, the method comprising:
providing a freight container comprising:
a freight deck for carrying freight, the freight deck having a first end, a second end, and opposing side edges;
a first support yoke comprising:
two first yoke support posts each having a distal end and a deck end; and
a first yoke crossmember,
each first yoke support post connected at its distal end to the first yoke cross member and rotatably connected at its deck end to the freight deck, at matching points along the opposing side edges of the freight deck inwards from the first end thereof, such that the first support yoke from a transport position approximately perpendicular to the surface of the freight deck can pivot towards the center point of the freight deck, being a storage position;
a second support yoke comprising:
two second yoke support posts each having a distal end and a deck end; and
a second yoke crossmember,
each second yoke support post connected at its distal end to the second yoke cross member and rotatably connected at its deck end to the freight deck, at matching points along the opposing side edges of the freight deck inwards from the second end thereof, such that the second support yoke from a transport position approximately perpendicular to the surface of the freight deck can pivot towards the center point of the freight deck, being a storage position;
wherein each of the first and second support yokes can be supported and locked in their respective transport and storage positions; and
wherein upon movement of each of the first and second support yokes to their storage positions the first and second yoke crossmembers will be approximately folded down flat upon the surface of the freight deck, being the storage condition of the container;
loading the materials to be transported onto the freight deck; and
moving and locking the first and second support yokes into their upright transport positions, yielding the loaded collapsible freight container.

38. The method of claim 37 wherein
the first support yoke can be pivoted from its perpendicular transport position towards the first end of the freight deck, being a loading position; and
the second support yoke can be pivoted from its perpendicular transport position towards the second end of the freight deck, being a loading position;
wherein upon movement of each of the first and second support yokes to their loading positions substantially all of the freight deck is exposed for unimpeded movement of payload upon the freight deck within the payload area defined by the dimensions of the freight deck and the inside of the support yokes when in their approximately perpendicular transport positions;
the method further comprising moving the first and second support yokes into their loading positions before loading the materials to be transported onto the freight deck.

39. The method of claim 37 wherein either support yoke is extensible in height.

40. The method of claim 37 wherein either support yoke is extensible in height, and wherein the method further comprises extending the support yokes to remove the yoke crossmembers from any impedance of top access to the freight deck, in advance of loading the freight deck.

41. The method of claim 37 further comprising:
lifting the loaded collapsible freight container onto a conveyance; and
transporting the freight container and materials using the conveyance.

42. The method of claim 41, wherein the conveyance comprises one of a ship, a truck, or a rail chassis.
